(19) United States
(12) Patent Application Publication
(10) Pub. No.: US 2011/0153107 A1
(43) Pub. Date: Jun. 23, 2011

(54) APPARATUS AND METHOD FOR SMART ENERGY MANAGEMENT BY CONTROLLING POWER CONSUMPTION

(75) Inventors: Kwang-Soo KIM, Daejeon (KR); Tae-Wook Heo, Daejeon (KR); Seung-Ki Hong, Daejeon (KR); Yoon-Mee Doh, Daejeon (KR); Woo-Sug Jung, Daejeon (KR); Hyun-Hak Kim, Daejeon (KR); Jong-Arm Jun, Daejeon (KR); No-Seong Park, Daejeon (KR); Ki-Sung Lee, Daejeon (KR)

(73) Assignee: Electronics and Telecommunications Research Institute, Daejeon (KR)

(21) Appl. No.: 12/877,288

(22) Filed: Sep. 8, 2010

(30) Foreign Application Priority Data
Dec. 18, 2009 (KR) 10-2009-0126730
Feb. 19, 2010 (KR) 10-2010-0015266

(51) Int. Cl. G05D 7/06

(52) U.S. Cl. 700/295

(57) ABSTRACT

Disclosed are an apparatus and a method for smart energy management by controlling power consumption. Power consumption information is collected from one or more electrical device groups with a smart meter and electrical devices connected through gateways. When the method estimates that the power consumption will be larger than a threshold value, a control command is outputted to a load controller connected through the gateway and power consumption of electrical devices that belong to the electrical device using group is remotely controlled. According to an embodiment of the present invention, an energy company that produces and supplies energy can supply energy depending on a consumer's demand by using current facilities because the present invention can collect remotely energy consumption, analyze energy consumption patterns, and control automatically the energy consumption of electrical devices installed in a customer's area. The consumer who consumes energy can save the energy consumption and the charge of the energy consumption.

### CROSS REFERENCE TO RELATED APPLICATIONS

This application claims priority to Korean Patent Application No. 10-2009-0126730 filed on Dec. 18, 2009 and Korean Patent Application No. 10-2010-0015266 filed on Feb. 19, 2010, the entire contents of which are herein incorporated by reference.

### BACKGROUND OF THE INVENTION

1. Field of the Invention

The present invention relates to an apparatus and a method for smart energy management by controlling power consumption, and more particularly, to an apparatus and a method for smart energy management to saving power consumption by remotely collecting an energy consumption, analyzing and estimating energy consumption patterns, and remotely controlling power consumption of an energy consumption apparatus in a smart grid field regarded as an essential technology for saving the energy consumption.

2. Description of the Related Art

A remote measurement system which is being used at present is configured as a technology that remotely measures an energy consumption of a meter (electric power, gas, water supply, etc.) installed in an energy consumer's residence or business, which primarily consumes energy and transmits the metering data to a central server. According to a previously applied patent, metering data of the meter is just transferred to the central server and does not provide a method for controlling energy consumption in the consumer.

Further, a unidirectional communication is used for data transmission. Under such an environment, data collected in the central server is being utilized as key information for determining the tendency of an energy consumption which is being consumed at present and plays an important role in controlling energy production and energy supply. However, the capacity of a facility producing energy is limitative. Therefore, when the energy consumption amount is larger than the maximum energy production, a problem such as electricity failure occurs, thereby causing considerable social and economical damages.

In order to prevent the problem from being generated, production facilities should be extended in order to increase the energy production amount as much as the increased energy consumption. However, the energy consumption dramatically increases on a predetermined season (e.g., summer or winter) and after the corresponding period, the energy consumption decreases. Therefore, since the extended production facilities operate for a short period and stop for the rest of the period, a continuous increase of the production facilities causes large cost expenditure and exists as non-operational facilities in energy production companies.

### SUMMARY OF THE INVENTION

There is an object to provide an apparatus and a method for smart energy management for saving an energy consumption amount by remotely controlling an energy consumption apparatus that is being operated in an energy consumer's residence or business when the energy consumption amount of the consumer is larger than a predetermined threshold by analyzing and estimating the energy consumption amount of the consumer as well as storing a remote measurement result in a server.

In order to achieve the above-mentioned object, according to an aspect of the present invention, there is provided a smart energy management apparatus controlling power consumption that includes: a data collection module that is connected with one or more electrical device using groups through gateways to collect power consumption information of the electrical device using groups; a consumption pattern analysis module that analyzes the power consumption data to acquire a power consumption pattern of the electrical device using groups; a consumption estimation module that estimates a power consumption for a predetermined period on the basis of the power consumption pattern of the electrical device using groups; and a control command generation module that outputs a control command to limit power consumption of the electrical device using groups.

The control command generation module outputs the control command for an electrical device using group of which the estimated power consumption is larger than a threshold value.

The smart energy management apparatus further includes a communication control module controlling transmission and reception of a signal to and from the electrical device using group through the gateway.

The gateway includes: an energy service portal (ESP) module accessing a network of the electrical device using groups to transmit and receive data in a ZigBee communication scheme; a communication control module connected with the data collection module in the wired scheme to transmit and receive data; and a conversion module converting a communication scheme of signals transmitted and received between the network of the electrical device using groups and the data collection module.

The electrical device using group includes a smart meter that is connected with electrical devices that belong to the electrical device using group and measures the power consumption of the electrical device using group.

The electrical device using group further includes a load controller that is connected with the electrical devices which belongs to the electrical device using group and controls power consumption of the electrical devices in accordance with the control command from the control command generation module.

The load controller includes at least one of a smart energy display (SED), an infrared load control device (IR_LCD), and a load control device (LCD).

The SED includes: an information display module displaying at least one of the power consumption information and the control command from the gateway; and a ZigBee communication module communicating with the gateway.

The LCD includes: the ZigBee communication module communicating with the gateway and the electrical device; a device identification module identifying a connected electrical device; a measurement module measuring a power consumption of the connected electrical devices; and an operation control module controlling power consumption of the electrical devices in accordance with the control command from the gateway.

The IR_LCD includes: the ZigBee communication module communicating with the gateway; an infrared communication module communicating with the connected electrical devices; the device identification module identifying the electrical devices; and the operation control module controlling the power consumption of the electrical devices in accordance with the control command from the gateway.

Meanwhile, the smart energy management apparatus according to the aspect of the present invention further includes a group management module managing group information on the electrical device using group including energy metering devices and energy consuming devices.

Further, the smart energy management apparatus according to the aspect of the present invention further includes a device management module managing device information of the electrical devices that belongs to the electrical device using group.

The device management module transmits information on an electrical device added to the electrical device using group to an authentication server and manages the added electrical device on the basis of a legality examination result from the authentication server.

Meanwhile, in order to achieve the above-mentioned object, according to another aspect of the present invention, there is provided a smart energy management method controlling power consumption that includes: collecting power consumption information of one or more electrical device using groups through gateways; acquiring a power consumption pattern of the electrical device using groups by analyzing the power consumption information; estimating power consumption for a predetermined period on the basis of the power consumption pattern of the electrical device using groups; and outputting a control command to limit power consumption of the electrical device using groups.

The outputting outputs the control command for the electrical device using group of which the estimated power consumption is larger than a threshold value.

The collecting receives the power consumption information from the smart meter, that is connected with electrical devices that belong to the electrical device using group and measures the power consumption of the electrical device using group, and an LCD that measures the power consumption of connected electrical device.

The smart energy management method further includes transmitting the control command to an electrical device using group of which the estimated power consumption is larger than a threshold value through the gateway.

The transmitting transmits the control command to a load controller that is connected with the electrical devices which belongs to the electrical device using group and controls the power consumption of the electrical device.

The gateway transmits and receives a signal to and from the electrical device using group in a ZigBee communication scheme.

The smart energy management method further includes collecting and managing group information on the electrical device using groups.

The smart energy management method further includes collecting and managing device information of the electrical devices that belongs to the electrical device using group.

According to an embodiment of the present invention, an energy company that produces and supplies energy can supply energy depending on a consumer's request by using current facilities by remotely collecting an energy consumption and analyzing energy consumption patterns in a smart grid field without installing additional energy production and supplying facilities with a continuous increment of the energy consumption and the consumer who consumes energy can save the energy consumption and charge of energy consumption.

### BRIEF DESCRIPTION OF THE DRAWINGS

FIG. 1 is a diagram showing a system configuration of a smart energy management system of an electrical device using group adopting a smart energy management apparatus according to an embodiment of the present invention;

FIG. 2 is a block diagram referenced for describing a configuration of a management server according to an embodiment of the present invention;

FIG. 3 is a block diagram referenced for describing a configuration of a gateway according to an embodiment of the present invention;

FIGS. 4 to 7 are diagrams referenced for describing a configuration of a load controller according to an embodiment of the present invention;

FIG. 8 is a block diagram referenced for describing a configuration of an authentication server according to an embodiment of the present invention; and

FIG. 9 is a flowchart showing an operational flow of a smart energy management method according to an embodiment of the present invention.

### DETAILED DESCRIPTION OF THE PREFERRED EMBODIMENTS

Hereinafter, embodiments of the present invention will be described with reference to the accompanying drawings.

A smart energy management apparatus according to an embodiment of the present invention collects power consumption information of all power consumption apparatuses and customers from smart meters and LCDs installed in a home of a consumer, a building, a factory, or the like that uses electrical power and when it judges that power consumption is generated at a threshold value or more, the smart energy management apparatus controls power consumption amounts of electrical devices in accordance with a pre-contract with the corresponding customer.

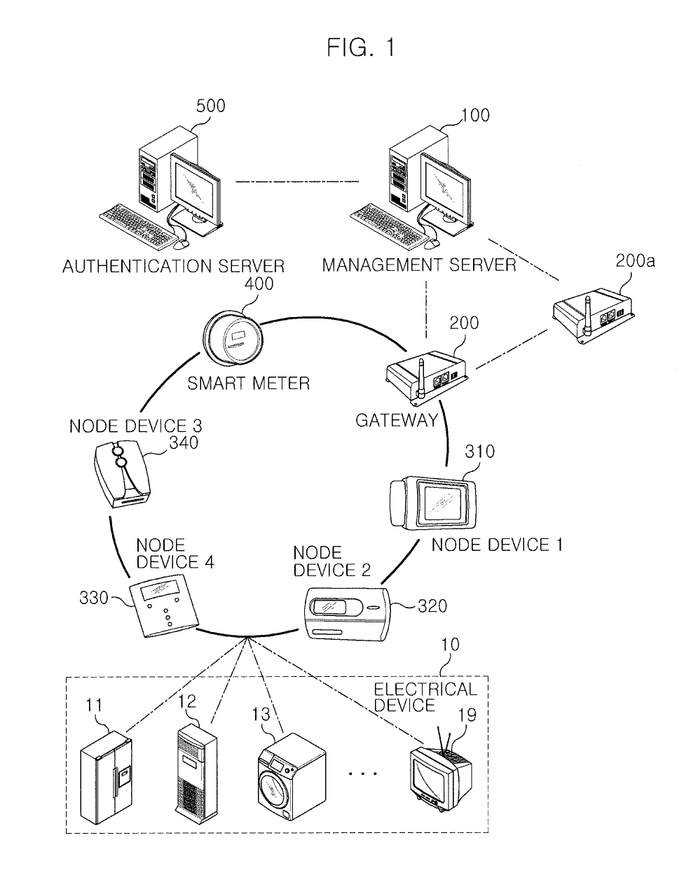

FIG. 1 is a diagram showing a system configuration of a smart energy management system of an electrical device using group adopting a smart energy management apparatus according to an embodiment of the present invention. The smart energy management apparatus according to the embodiment of the present invention will now be referred to as a ‘management server’.

As shown in FIG. 1, a smart energy management system implemented by the present invention, the management server 100 is connected with one or more electrical device using group with electrical devices through a gateway 200. Although one gateway 200 and one electrical device using group connected thereto are shown in FIG. 1, more gateways 200a and more electrical device using groups connected thereto may be connected to the management server 100.

Herein, the electrical device using group includes an electrical device 10, a smart meter 400 measuring power consumption of the electrical devices 10 that belongs to the electrical device using group, and a load controller, as node devices 310, 320, 330, and 340, controlling the power consumption of the electrical device 10 that belongs to the electrical device using group in accordance with a control command from the management server 100.

Further, in the electrical device using group, the electrical device 10, the smart meter 400, and the load controller are connected to a network of a ZigBee wireless communication scheme to share information with each other.

The electrical device 10 may correspond to a refrigerator 11, an air-conditioner 12, a wash machine 13, a TV19, etc. that consume electrical power in the home and correspond to various machines in a factory.

The gateway 200 is accessible to the network of the electrical device using group by using the ZigBee communication scheme. Further, the gateway 200 is connected with the management server 100 by a wired communication scheme. Of course, the gateway 200 may also be connected with the management server 100 by a wireless communication scheme in accordance with a connection set-up.

Herein, the gateway 200 serves as a relay between the electrical device using group and the management server 100. Further, the gateway 200 serves to collect power consumption information measured by the electrical device using group and provide the information to the management server 100.

At this time, the gateway 200 corresponds to one electrical device using group one to one. In other words, another electrical device using group transmits and receives signals to and from the management server 100 by using another gateway 200.

The management server 100 acquires a consumption pattern for the electrical device using group by analyzing the power consumption information from the gateway 200 and estimates power consumption. At this time, the management server 100 outputs a control command to the load controller of the electrical device using group in accordance with contents of a contract which is agreed with a customer of the electrical device using group when the estimated power consumption amount is larger than a threshold value.

Therefore, the load controller of the electrical device using group intercepts the consumption of electrical power of the electrical device 10 in accordance with the control command from the management server 100 so as to limit energy consumption of the electrical device using group.

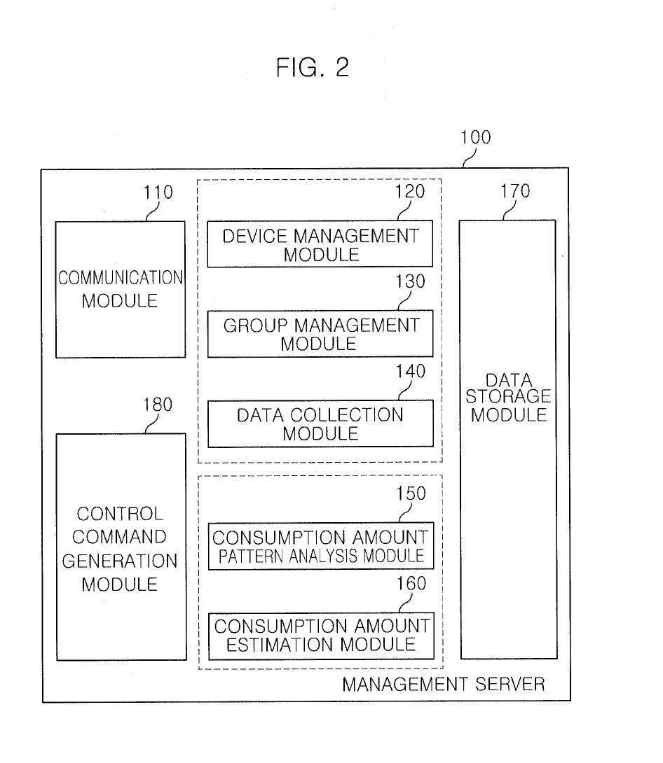

Therefore, referring to FIG. 2, a configuration of the management server according to the embodiment of the present invention will be described in more detail. FIG. 2 is a block diagram referenced for describing a configuration of a management server according to an embodiment of the present invention.

As shown in FIG. 2, the management server 100 according to the embodiment of the present invention includes a communication module 110, a device management module 120, a group management module 130, a data collection module 140, a consumption pattern analysis module 150, a consumption estimation module 160, a data storage module 170, and a control command generation module 180.

First, the communication module 110 is connected with the gateway 200 in a wired scheme to receive the power consumption information of the electrical device using group collected in the gateway 200 or transmit the control command of the management server 100 for the electrical device using group to the gateway 200.

The device management module 120 manages device information of the electrical device 10 that belongs to the electrical device using group. Specifically, the device management module 120 manages unique information including a serial number, a model, etc. of the electrical device 10 and manages power limitation priority information, etc. of the electrical device 10. At this time, the device management module 120 classifies and manages device information for each electrical device using group.

Further, the device management module 120 manages information on the smart meter 400, the load controller, etc. that belong to the electrical device using group.

At this time, the group management module 130 manages customer information for electrical device using group. At this time, the group management module 130 manages contents of a contract including the power consumption, the charge of power consumption, etc., which is agreed with the customer.

Meanwhile, the data collection module 140 collects power consumption information for an electrical device using group connected through the gateway 200 and the consumption pattern analysis module 150 analyzes the collected power consumption information to acquire a power consumption pattern of the electrical device using group. Further, the consumption pattern analysis module 150 may calculate a cost depending on the power consumption of the electrical device using group.

Further, the consumption estimation module 160 estimates the power consumption on the basis of the power consumption pattern of the electrical device using group.

As an example, the consumption estimation module 160 estimates a power consumption consumed for a predetermined period on the basis of the corresponding period.

In this case, the consumption estimation module 160 estimates the power consumption consumed for the predetermined period to allow the customer, that is, a power consumer to verify whether or not the power consumption is larger than a threshold value even though the predetermine period does not elapse.

Meanwhile, the data storage module 170 stores the customer information of the electrical device using group and the device information of the electrical device 10 that belongs to the electrical device using group, and in addition, stores the power consumption information collected by the data collection module 140. Further, the data storage module 170 stores output data from the consumption pattern analysis module 150 and the consumption estimation module 160.

Further, the control command generation module 180 generates a control command for the electrical device using group on the basis of the estimated power consumption.

At this time, the control command generation module 180 compares the threshold value with the estimated power consumption and when the estimated power consumption is larger than the threshold value, the control command generation module 180 generates a control command to limit power consumption of the electrical device 10 that belongs to the electrical device using group.

Herein, in the case of the control command, a corresponding command may be generated for each electrical device 10 that belongs to the electrical device using group on the basis of the device information stored in the data storage module 170. At this time, the generated control command may include identification information on the electrical device 10 for executing the corresponding control command.

Further, the threshold value is defined depending on contract contents of a customer registered by the group management module 130. The threshold value may be reference power consumption or the charge of the power consumption depending on the power consumption.

At this time, the control command generation module 180 outputs the control command through the communication module 110. The control command outputted through the communication module 110 is transmitted to the load controller of the electrical device using group through the gateway 200.

Meanwhile, the control command generation module 180 generates and transmits a message for notifying a start of a control to limit the electrical power of the electrical device 10 to the customer.

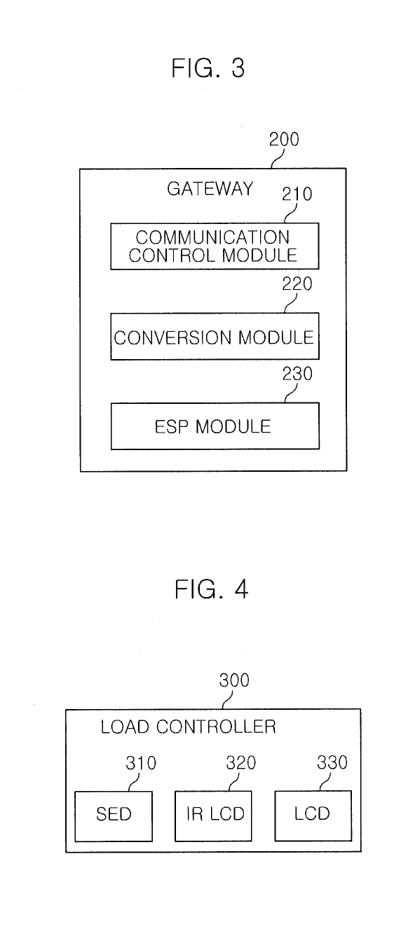

Meanwhile, FIG. 3 is a block diagram referenced for describing a configuration of a gateway according to an embodiment of the present invention and referring to FIG. 3, the configuration of the gateway according to the embodiment of the present invention will be described in detail.

As shown in FIG. 3, the gateway 200 accesses the network of the electrical device using group in the ZigBee wireless communication scheme to connect the electrical device 10, the load controller including an SED 310, an IR_LCD 320, an LCD 330, etc., and the smart meter 400. Accordingly, the gateway 200 exchanges information with the smart meter 400 and the load controller.

At this time, the gateway 200 includes a communication control module 210, which is connected with the management server 100 in a wired scheme and transmits and receive data, a conversion module 220 that converts a communication scheme of a signal transmitted and received between the electrical device using group and the management server 100 and an energy service portal (ESP) module 230 that accesses the electrical device using group in the ZigBee communication scheme to transmit and receive data.

Herein the ESP module 230 is connected with the smart meter 400 and the load controller to receive the power consumption information of the electrical device 10 from the smart meter 400 and transmit the control command from the management server 100 to the load controller.

Meanwhile, the conversion module 220 converts the signal of the ZigBee communication scheme received by the ESP module 230 to a signal of the wired communication scheme recognizable by the communication control module 210. Further, the conversion module 220 converts the control command from the management server 100 inputted into the communication control module 210 into the signal of the wired communication scheme to the signal of the ZigBee communication scheme to allow the ESP module 230 to recognize the control command.

Meanwhile, FIGS. 4 to 7 are block diagrams referenced for describing a configuration of a load controller according to an embodiment of the present invention and referring to FIGS. 4 to 7, the configuration of the load controller according to the embodiment of the present invention will be described in detail.

FIG. 4 shows node devices corresponding to the load controller 300 and as shown in FIG. 4, the load controller 300 includes the smart energy display (SED) 310, the infrared load control device (IR_LCD) 320, the load control device (LCD) 330, etc.

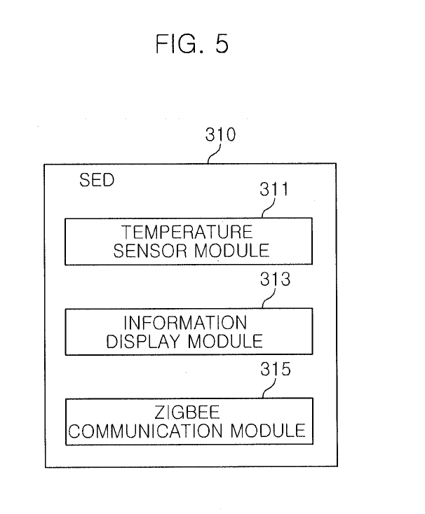

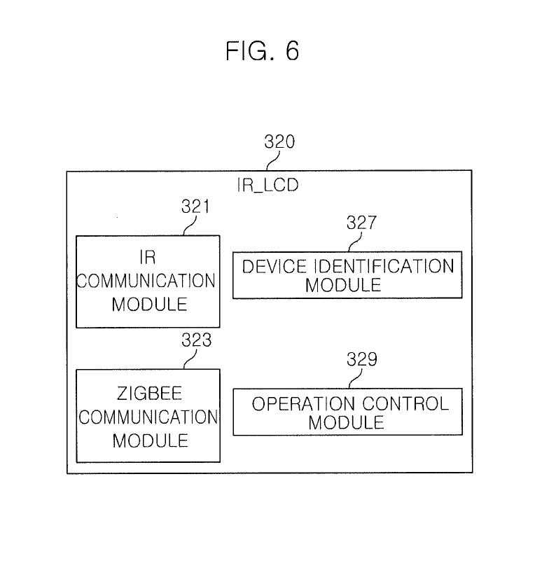

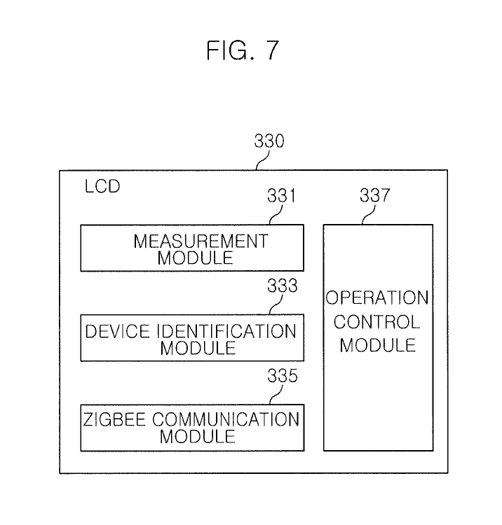

Herein, a detailed configuration of the SED 310 will be described with reference to FIG. 5, a detailed configuration of the IR_LCD 320 will be described with reference to FIG. 6. Further, a detailed configuration of the LCD 330 will be described with reference to FIG. 7.

First, as shown in FIG. 5, the SED 310 includes a temperature sensor module 311 measuring room temperature, an information display module 313 displaying the measured room temperature, a control command and a notification message from the gateway 200, etc., and energy consumption information including a current consumed energy consumption amount, an energy consumption charge, etc., and a ZigBee communication module 315 communicating with the ESP module 230 of the gateway 200.

Meanwhile, as shown in FIG. 6, the IR_LCD 320 includes an infrared (IR) communication module 321 communicating with the connected electrical device 10, a ZigBee communication module 323 communicating with the ESP module 230 of the gateway 200, a device identification module 327 identifying the electrical device 10 connected through the IR communication module 321, and an operation control module 329 controlling power consumption of the electrical device 10 in accordance with the control command from the gateway 200.

At this time, the operation control module 329 may limit power consumption of the corresponding electrical device 10 on the basis of the identification information of the electrical device 10 included in the control command. Meanwhile, the operation control module 329 may, according to a priority of electrical devices 10 preregistered in the IR_LCD 320, limit power consumption of the corresponding electrical device 10.

Meanwhile, as shown in FIG. 7, the LCD 330 includes a measurement module 331 measuring a power consumption amount consumed by the electrical device 10, a device identification module 333 identifying the connected electrical device 10, a ZigBee communication module 335 communicating with the ESP module 230 of the gateway 200, and an operation control module 337 controlling power consumption of the electrical device 10 in accordance with the control command from the gateway 200.

At this time, the operation control module 337 may limit power consumption of the corresponding electrical device 10 on the basis of the identification information of the electrical device 10 included in the control command. Meanwhile, the operation control module 337 may, according to a priority of electrical devices 10 preregistered in the LCD 330, limit power consumption of the corresponding electrical device 10.

Herein, the IR_LCD 320 is wirelessly connected with the electrical devices 10 such as an air-conditioner 12, a TV 19, etc., which are controllable by a wireless remote controller using an infrared communication. Further, the LCD 330 may generally be directly connected with a refrigerator 11, a wash machine 13, a computer, etc. that consume electrical power.

As one example, the IR_LCD 320 increases the set temperature of the air-conditioner 12 without inconveniencing an indoor resident and stops the air-conditioner 12 for a predetermined period. Further, the LCD 330 stops the wash machine 13 for a predetermined period and thereafter, restarts the wash machine 13 when the power consumption amount is lower than a predetermined level.

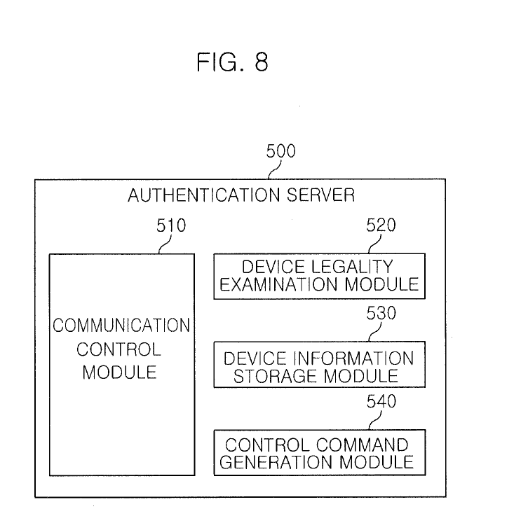

FIG. 8 is a block diagram referenced for describing a configuration of an authentication server according to an embodiment of the present invention. The authentication server 500 serves to examine the legality of an electrical device 10 additionally installed in the electrical device using group. Of course, the authentication server 500 may examine the legalities of the SED 310, the IR_LCD 320, the LCD 330, the smart meter 400, etc., in addition to the electrical device 10.

As shown in FIG. 8, the authentication server 500 includes a communication control module 510, a device legality examination module 520, a device information storage module 530, and a control command generation module 540.

The communication control module 510 receives information of the electrical device 10 for examining the legality of the corresponding device 10 from the management server 100. Further, the communication control module 510 transmits the legality examination result of the corresponding electrical device 10 to the management server 100.

The information of the electrical device 10 transmitted from the management server 100 is stored in the device information storage module 530.

Thereafter, the device legality examination module 520 examines the legality on the basis of the information stored in the device information storage module 530. At this time, the device legality examination module 520 examines whether the corresponding electrical devices are legally purchased or installed. The legality examination result by the device legality examination module 520 is stored in the device information storage module.

If it is judged that the corresponding electrical devices 10 are illegal devices by the device legality examination module 520, the control command generation module 540 generates a command to remote the corresponding electrical device 10 from the network and transmits the control command to the management server 100 through the communication control module 510.

Of course, if it is judged that the corresponding electrical devices 10 are legal devices by the device legality examination module 520, the control command generation module 540 generates a command to maintain the corresponding electrical devices 10 in the network and transmits the control command to the management server 100 through the communication control module 510.

Meanwhile, the management server 100 transmits the legality examination result from the authentication server 500, to the device management module 120. Accordingly, the device management module 120 manages the corresponding electrical device 10 to be removed from or maintained in the network depending on the control command from the authentication server 500.

The operation of the present invention configured as above will now be described in more detail.

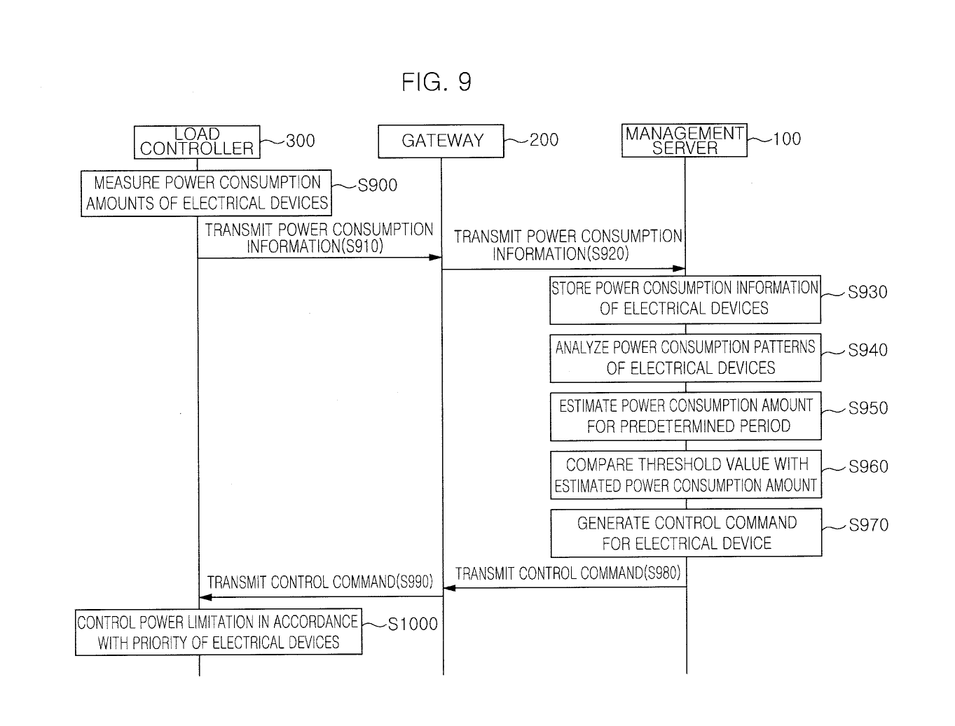

FIG. 9 is a flowchart showing an operational flow of a smart energy management method according to an embodiment of the present invention.

As shown in FIG. 9, the smart meter 400 connected with the electrical device 10 that belongs to the electrical device using group or the LCD 330 of the load controller 300 measures the power consumption amount of the electrical device 10 (S900). At this time, the smart meter 400 transmits the power consumption information of the electrical device using group and the LCD 330 transmits power consumption information of each connected electrical device to the gateway 200 (S910).

The gateway 200 receives the power consumption information of the electrical device 10 that belongs to the electrical device (10) using group from the smarter meter 400 or the LCD 330 (S910) and transmits it to the management server 100 (S920). At this time, the signal of the ZigBee communication scheme received from the smart meter 400 or the LCD 330 is transmitted while being converted into the signal of the wired communication scheme recognizable by the management server 100.

Meanwhile, the management server 100 collects the power consumption information of the electrical device using group from the gateway 200 and stores it (S930).

At this time, the management server 100 analyzes the collected power consumption information to acquire the power consumption pattern of the electrical device using group (S940) and estimates the power consumption for a predetermined period on the basis of the acquired power consumption pattern (S950). Further, the management server 100 compares the threshold value with the estimated power consumption (S960) and according to the result, the management server 100 generates the control command to limit the power consumption of the electrical device 10 of the electrical device using group (S970). At step ‘S960’, the management server 100 performs a step after step ‘S970’ when the estimation result of the power consumption is larger than the threshold value.

The control command generated at step ‘S970’ is transmitted to the load controller 300 controlling the electrical device 10 that belongs to the electrical device using group through the gateway 200 (S980 and S990). At this time, the gateway 200 converts the control command from the management server 100 into the signal of the ZigBee communication scheme from the signal of the wired communication scheme and transmits it to the load controller 300.

Accordingly, the load controller 300 controls power consumption of the corresponding device 10 in accordance with the control command from the management server 100 or outputs a control message included in the control command to notify execution of power control to a user (S1000).

As described above, the apparatus and method for smart energy management by controlling power consumption according to the embodiment of the present invention are not limited to the configuration and method of the embodiments described as above, but the embodiments may be configured by selectively combining all the embodiments or some of the embodiments so that various modifications can be made.

What is claimed is:

1. A smart energy management apparatus controlling power consumption, comprising:
a data collection module that is connected with one or more electrical device groups through gateways to collect power consumption information of the electrical device using groups;
a consumption pattern analysis module that analyzes the power consumption information to acquire a power consumption pattern of the electrical device using groups;
a consumption estimation module that estimates power consumption for a predetermined period on the basis of the power consumption pattern of the electrical device using groups; and
a control command generation module that outputs a control command to limit power consumption of the electrical device using groups.

2. The smart energy management apparatus controlling power consumption according to claim 1, wherein the control command generation module outputs the control command for a electrical device using group of which the estimated power consumption is larger than a threshold value.

3. The smart energy management apparatus controlling power consumption according to claim 1, further comprising: a communication control module controlling transmission and reception of a signal to and from the electrical device using group through the gateway.

4. The smart energy management apparatus controlling power consumption according to claim 1, wherein the gateway includes:
an energy service portal (ESP) module accessing network of the electrical device using groups to transmit and receive data in a ZigBee communication scheme;
a communication control module connected with the data collection module in the wired scheme to transit and receive data; and
a conversion module converting a communication scheme of signals transmitted and received between the network of the electrical device using groups and the data collection module.

5. The smart energy management apparatus controlling power consumption according to claim 1, wherein the electrical device using group includes a smart meter that is connected with electrical devices that belong to the electrical device using group and measures the power consumption of the electrical device using group.

6. The smart energy management apparatus controlling power consumption according to claim 1, wherein the electrical device using group further includes a load controller that is connected with the electrical devices which belongs to the electrical device using group and controls power consumption of the electrical devices in accordance with the control command from the control command generation module.

7. The smart energy management apparatus controlling power consumption according to claim 6, wherein the load controller includes at least one of a smart energy display (SED), an infrared load control device (IR_LCD), and a load control device (LCD).

8. The smart energy management apparatus controlling power consumption according to claim 7, wherein the SED includes:
an information display module displaying at least one of the power consumption information and the control command from the gateway; and
a ZigBee communication module communicating with the gateway.

9. The smart energy management apparatus controlling power consumption according to claim 7, wherein the LCD includes:
the ZigBee communication module communicating with the gateway and the electrical device;
a device identification module identifying a connected electrical device;
a measurement module measuring a power consumption of the connected electrical devices; and
an operation control module controlling power consumption of the electrical devices in accordance with the control command from the gateway.

10. The smart energy management apparatus controlling power consumption according to claim 7, wherein the IR_LCD includes:
the ZigBee communication module communicating with the gateway;
an infrared communication module communicating with the connected electrical devices;
the device identification module identifying the electrical devices; and
the operation control module controlling the power consumption of the electrical devices in accordance with the control command from the gateway.

11. The smart energy management apparatus controlling power consumption according to claim 1, further comprising: a group management module managing group information on the electrical device using group.

12. The smart energy management apparatus controlling power consumption according to claim 1, further comprising: a device management module managing device information of the electrical devices that belongs to the electrical device using group.

13. The smart energy management apparatus controlling power consumption according to claim 12, wherein the device management module transmits information on an electrical device added to the electrical device using group to an authentication server and manages the added electrical device on the basis of a legality examination result from the authentication server.

14. A smart energy management method controlling power consumption, comprising:
collecting power consumption information of one or more electrical device using groups through a gateways;
acquiring a power consumption pattern of the electrical device using groups by analyzing the power consumption information;
estimating power consumption for a predetermined period on the basis of the power consumption pattern of the electrical device using groups; and
outputting a control command to limit power consumption of the electrical device using groups.

15. The smart energy management method controlling power consumption according to claim 14, wherein the outputting outputs the control command for the electrical device using group of which the estimated power consumption is larger than a threshold value.

16. The smart energy management method controlling power consumption according to claim 14, wherein the collecting receives the power consumption information from the smart meter, that is connected with electrical devices that belong to the electrical device using group and measures the power consumption of the electrical device using group, and an LCD that measures the power consumption of connected electrical device.

17. The smart energy management method controlling power consumption according to claim 14, further comprising: transmitting the control command to an electrical device using group of which the estimated power consumption is larger than a threshold value through the gateway.

18. The smart energy management method controlling power consumption according to claim 17, wherein the transmitting transmits the control command to a load controller that is connected with the electrical devices which belongs to the electrical device using group and controls the power consumption of the electrical devices.

19. The smart energy management method controlling power consumption according to claim 14, wherein the gateway transmits and receives a signal to and from the electrical device using group in a ZigBee communication scheme.

20. The smart energy management method controlling power consumption according to claim 14, further comprising: collecting and managing device information of the electrical devices that belongs to the electrical device using group.
